(19) United States
(12) Patent Application Publication
(10) Pub. No.: US 2015/0053801 A1
(43) Pub. Date: Feb. 26, 2015

(54) Automatic Electronic Pill Crusher

(71) Applicant: Tanya Smit, Encino, CA (US)

(72) Inventor: Tanya Smit, Encino, CA (US)

(21) Appl. No.: 13/973,901

(22) Filed: Aug. 22, 2013

(51) Int. Cl. A61J 7/00; B02C 18/08

(52) U.S. Cl. CPC A61J 7/0007; B02C 18/08
USPC 241/100

(57) ABSTRACT

The invention provides a pill crusher device which is spherical or ovoid in shape having a top port for inserting pills to be crushed and a bottom port for releasing and pouring the powdered medication. The device comprises a molded plastic casing which encloses an oscillating electric motor which is activates a rapid orbital or oscillating motion to a pair of concentric serrated jaws or toothed rings located in the interior of the device wherein the outer toothed ring inhabits the inner surface of the casing and the inner toothed ring spins or oscillates in opposition to the fixed outer ring and grinds the pills against the teeth of the outer ring. The pills are quickly reduced to powder form.

### CLAIM OF PRIORITY

This patent application claims priority under 35 USC 119 (e) (1) from U.S. Provisional Patent Application Ser. No. 61/691,797 filed Aug. 22, 2012, of common inventorship herewith entitled, “Automatic Electronic Pill Crusher.”

### FIELD OF THE INVENTION

The present invention pertains to the field of pharmaceutical aids, and more specifically to the field of pill crushers.

### BACKGROUND OF THE INVENTION

The prior art has put forth several designs for pill crushers. Among these are:

U.S. Pat. No. 6,637,683 to Dimitria Michelle Lomax Wilbur describes a hand held pill crusher with an arm and base made of a hard and impervious material connected at one end so as to allow a vertical open and close movement to fragment and then crush pill into powdered form. The arm contains a plurality of stainless steel blades for fragmenting a pill and a crushing member made of similar hard and impervious material for reducing fragments to powder. The base contains a pill rack, threaded recess for crushing member and a track on underside for holding a spoon like receiving member.

U.S. Pat. No. 7,823,819 to Joyce Marshall describes a pill crushing device and its associated method of operation. The pill container is comprised of a container and a lid assembly that covers the container.

A pill to be crushed is placed inside the container and is automatically crushed using the power of a battery operated motor. A pill is introduced into the container through its open top end. A lid assembly is provided that is selectively attached over the open top end of the container. The lid assembly includes a ram that extends into the open top end of the container when the lid assembly is attached to the container. A battery operated motor is also provided in the lid assembly for raising and lowering the ram within said container. By attaching the lid assembly to the container and lowering the ram into the container, a pill can be crushed within the confines of the container.

U.S. Patent 2006/0151644 to Roy Smith and Kon Smith describes an electric hand held dosing device has an ergonomically shaped handle with an electrical switch. A spring loaded cap on the handle communicates with an internal hopper. A rotating grater blade is located in the hopper. The grater blade is connected to and rotated by a shaft powered by the power unit. The spring loaded cap opens to allow for the insertion of a pill or tablet into the hopper. The spring loading action of the door retains the pill within the hopper and forces the pill against the rotating grater blade. The pill particles exit through an outlet in the hopper. An impeller is mounted on the shaft and distributes the particles or mixes them with a carrier. In this manner, a one hand operation of the dosing device is effected.

None of these prior art references describe the present invention.

### SUMMARY OF THE INVENTION

It is an object of the present invention to provide an efficient handheld electronic pill crusher.

### BRIEF DESCRIPTION OF THE DRAWINGS

FIG. 1 is a prototypical perspective front view showing an activation (on) button, closed top lid and closed hinged bottom door.

FIG. 2 is a prototypical perspective side view showing the present invention having an activation button, closed top lid and open bottom door positioned above a three millimeter cup containing crushed medication.

FIG. 3 is a diagrammatical functional cut away view showing a battery insertion point, open top lid, teeth located inside of outer rim, inner grinding sphere, crushed pill output area and an open bottom door.

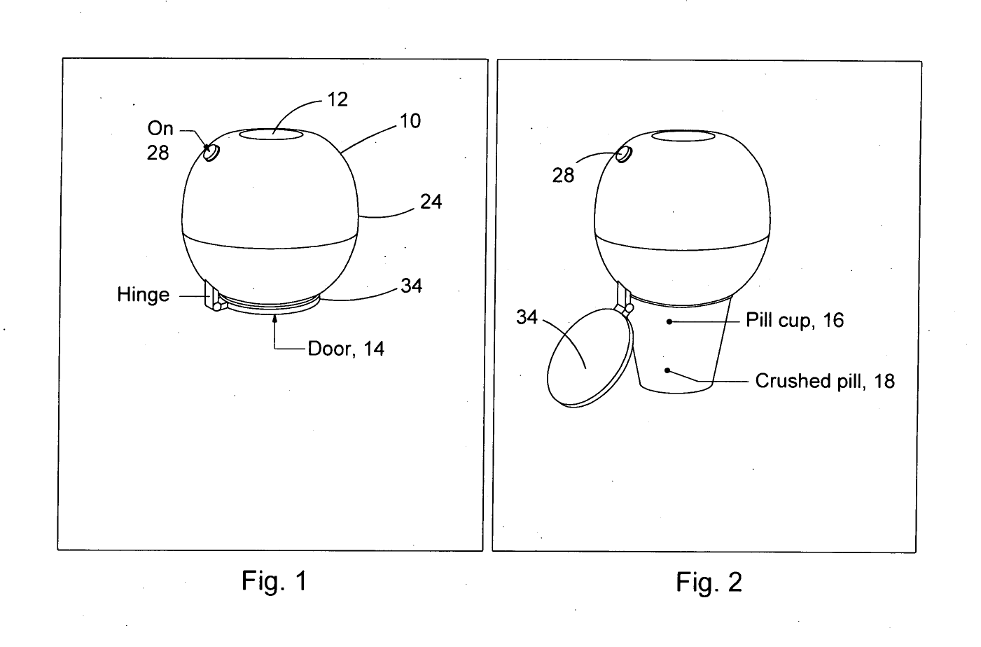

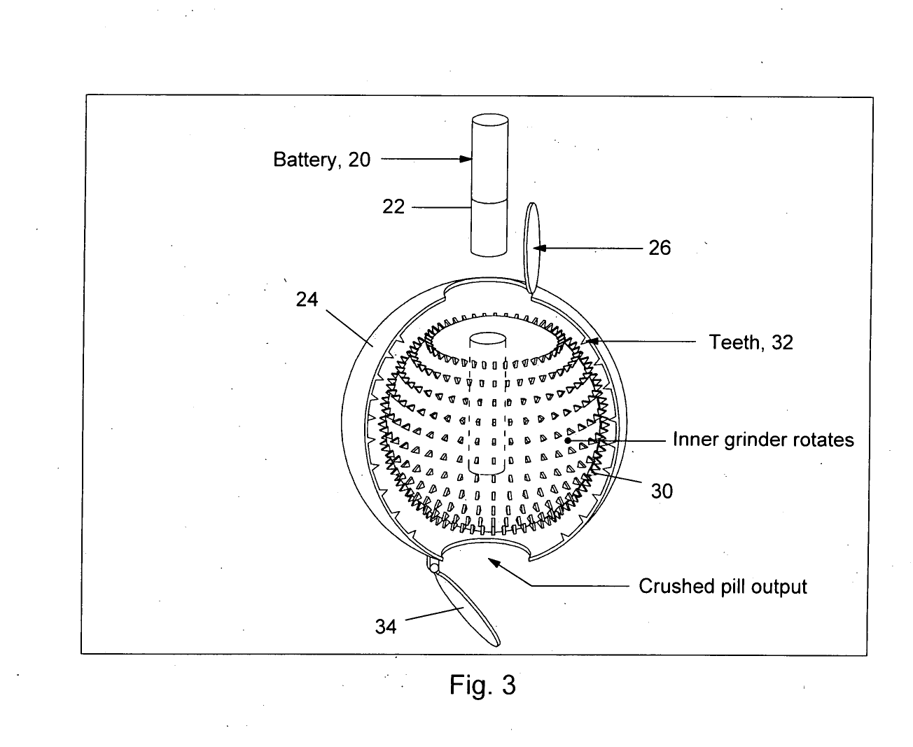

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

The present invention, hereinafter referred to as the Automatic Electronic Pill Crusher or the Pill Crusher, is a compact handheld battery powered device 10 for crushing pill form medications into powder. With a top port 12 for inserting pills to be crushed and a bottom port 14 for releasing and pouring the powdered medication 18 into a cup 16, the Automatic Electronic Pill Crusher is ideal for health care professionals and caregivers to use in hospitals, nursing homes, assisted living establishments and residential homes. The Automatic

Electronic Pill Crusher converts pill form medications into easily administered powders. The Pill Crusher, oval or spherical in shape and compact, is approximately ten to eleven centimeters in height, nine to ten centimeters in width, and two to two and one half centimeters in thickness. The crushing mechanism is powered by a single AA cell or AAA cell battery 20 contained in a snap cap compartment 22 within the Pill Crusher's molded plastic casing 24. The casing 24 is generally ovoid in shape with a flattened top and bottom. In the center of the top is a hinged snap cap hatch cover 26. This cover 26 opens to disclose a port 12 into which pills are dropped for crushing. The interior of the Pill Crusher contains an oscillating electric motor (not shown) which is activated by pressing a button 28 located on the exterior of the case. This motor provides a rapid orbital or oscillating motion to a pair of concentric serrated jaws 30 or toothed rings located in the interior of the device. The outer toothed ring 32 inhabits the inner surface of the casing and the inner toothed ring 30 spins or oscillates in opposition to the fixed outer ring 32 and grinds the pills against the teeth of the outer ring. The pills are quickly reduced to powder form that is conducted through a funnel channel to a base receptacle or cup. A second hinged snap cap 34 hatch or cover is located at the base receptacle to open and pour powdered medication into an approximately three milliliter medicine cup.

The Automatic Electronic Pill Crusher is useful for nurses making their rounds with patient medications in hospitals and nursing homes. The Pill Crusher is useful for elderly or partially disabled persons living on their own who prepare their own medications in powder form. The present invention is useful for parents of small children resistant or unable to swallow pills. The Pill Crusher is useful for dog and cat owners who wish to grind pet medications into powders to mix in their pet's food.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An efficient handheld electronic pill crusher device, comprising: a compact handheld battery powered device for crushing pill form medications into powder, further comprising a spherical, egg shaped, or ovoid plastic casing having a flattened top and a flattened bottom, further comprising a top port for inserting pills to be crushed and a bottom port for releasing and pouring the powdered medication into a cup, further comprising a crushing mechanism.

2. The efficient handheld electronic pill crusher device of claim 1, wherein the pill crushing device comprises an oscillating electric motor which is activated by pressing a button located on the exterior of the casing, wherein the motor provides a rapid orbital or oscillating motion to a pair of concentric serrated jaws or toothed rings located in the interior of the device, wherein the pair of concentric toothed rings comprise an outer toothed ring which inhabits the inner surface of the casing and an inner toothed ring spins or oscillates in opposition to the fixed outer tooth ring and grinds the pills against the teeth of the outer ring, thus creating a powder.

3. The efficient handheld electronic pill crusher device of claim 2 wherein the casing has a hinged snap cap hatch cover in the center of the top of the casing, wherein cover opens to expose a port into which pills are dropped for crushing.

4. The efficient handheld electronic pill crusher device of claim 3 wherein the casing has a second hinged snap cap hatch cover located at the base receptacle to open and pour powdered medication into a receptacle or cup.

5. The efficient handheld electronic pill crusher device of claim 2, wherein the casing is approximately ten to eleven centimeters in height, nine to ten centimeters in width, and two to two and one half centimeters in thickness.

6. The efficient handheld electronic pill crusher device of claim 2, wherein the crushing mechanism is powered by a single AA cell or AAA cell battery contained in a snap cap compartment within the plastic casing.
